(19) United States
(12) Patent Application Publication
(10) Pub. No.: US 2017/0001205 A1
(43) Pub. Date: Jan. 5, 2017

(54) WEAR-RESISTANT ASSEMBLY AND SPRAY NOZZLES PROVIDED THEREWITH

(71) Applicant: Powder Processing & Technology LLC, Valparaiso, IN (US)

(72) Inventor: Brad Steven Monton, Valparaiso, IN (US)

(21) Appl. No.: 14/790,291

(22) Filed: Jul. 2, 2015

(51) Int. Cl. B05B 1/34

(52) U.S. Cl. CPC B05B 1/3421

(57) ABSTRACT

Wear-resistant assemblies that may be installed for use in spray nozzle assemblies, and spray nozzle assembles equipped with such a component. Such an assembly includes a wear-resistant member having an axial surface and a base portion, and further includes a ring member having an inner perimeter that surrounds and contacts the outer perimeter of the base portion of the wear-resistant member. The ring member is formed of a material that is different from the material that defines the axial surface of the wear-resistant member, and less resistant to abrasive wear than the material of the axial surface.

### BACKGROUND OF THE INVENTION

The present invention generally relates to spray equipment and processes. The invention particularly relates to components of spray nozzles capable of exhibiting improved wear resistance.

Spray nozzles have various uses, including but not limited to spray drying, aeration, cooling, and fuel injection, which find use in food grade processing and industrial spray applications. In terms of spray drying, a nozzle injects a media, for example, a chemical solution or a slurry containing solid particles dispersed in a liquid, into an atmosphere, for example, a heated gaseous stream, that is capable of drying droplets of the media generated as the media exits through an orifice of the nozzle. A nozzle will typically be configured to generate droplets whose size and dispersion pattern will promote rapid drying. For this reason, a nozzle may have an internal swirl chamber that induces rotational flow in the media prior to being propelled through the nozzle orifice. However, the rotation induced in an abrasive media can result in rapid wear of components of the nozzle, which may lead to degradation of the dispersion pattern.

End plates are integral parts of spray nozzle assemblies (atomizers) that incorporate a swirl chamber to create a desired spray pattern. Spray media under high pressure impinge the end plate, which is disposed within the swirl chamber and is therefore subjected to the rotational flow of the media. As a result, end plates are subjected to wear during spray processes, particularly if the media is abrasive, for example, a slurry containing solid abrasive particles. The life of an end plate can vary from a few days to months, depending on the abrasiveness and chemical composition of the spray media. Current end plates are commonly formed of wear-resistant materials such as tungsten carbide (WC). However, even WC end plates can wear out quickly if the spray media is excessively abrasive.

Accordingly, there is an ongoing need to improve the useful lives of spray nozzle components, including end plates thereof.

### BRIEF DESCRIPTION OF THE INVENTION

The present invention provides a wear-resistant component that may be installed for use in a spray nozzle assembly, and to spray nozzle assembles equipped with such a component.

According to one aspect of the invention, an assembly includes a wear-resistant member comprising an axial surface and a base portion having an outer perimeter. The assembly further includes a ring member having an inner perimeter that surrounds and contacts the outer perimeter of the base portion of the wear-resistant member. The ring member is formed of a material that is different from a material that defines the axial surface of the wear-resistant member, and the material of the ring member is less resistant to abrasive wear than the material of the axial surface.

Another aspect of the invention is that the assembly is an end plate assembly of a spray nozzle assembly, and a spray nozzle assembly in which the end plate assembly is installed.

Other aspects and advantages of this invention will be appreciated from the following detailed description.

### BRIEF DESCRIPTION OF THE DRAWINGS

FIG. 1 is a cross-sectional view of a spray nozzle assembly of a type known in the art.

FIG. 2 is an image showing a perspective view of an end plate of a type represented in FIG. 1.

FIG. 3 is a perspective view of an end plate assembly suitable for use in the nozzle assembly of FIG. 1.

FIGS. 4 and 5 represent an end view and side view, respectively, of the end plate assembly of FIG. 3.

### DETAILED DESCRIPTION OF THE INVENTION

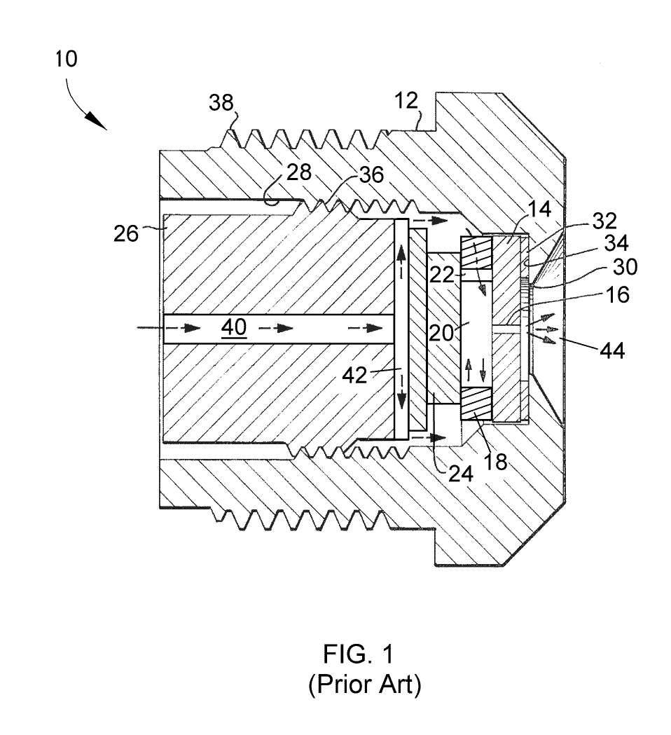

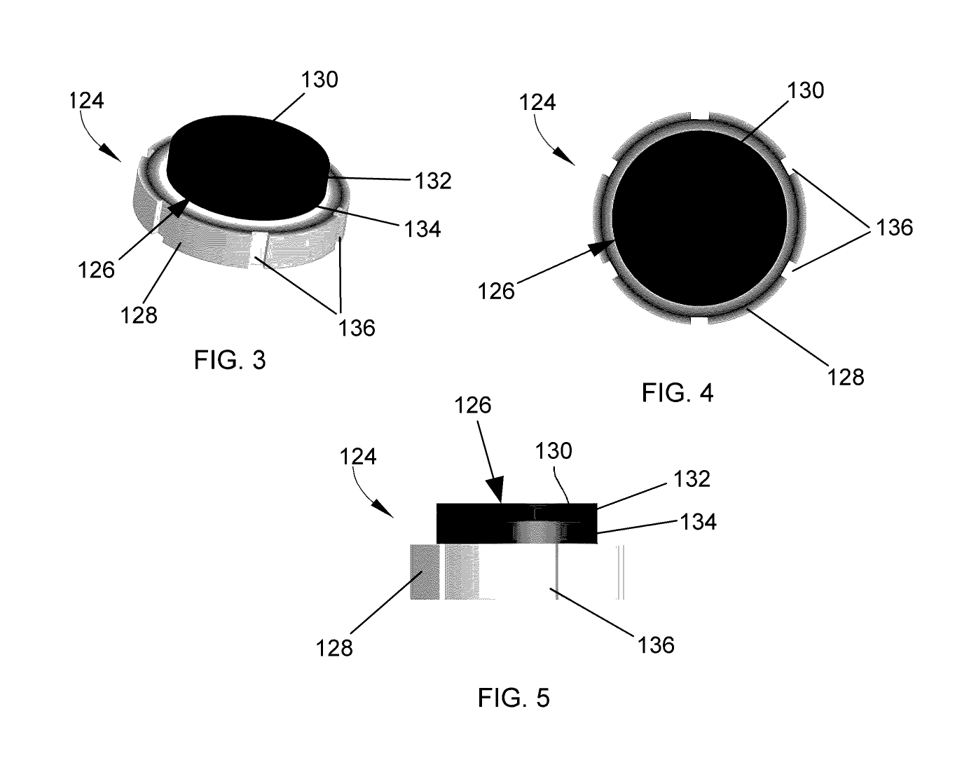

FIG. 1 represents a spray nozzle assembly 10 of a type known in the art, and FIGS. 3 through 5 represent views of an end plate assembly suitable for use in the nozzle assembly 10 of FIG. 1. The nozzle assembly 10 is of a type that can have various uses, including but not limited to spray drying, aeration, cooling, and fuel injection. Although the invention will be described hereinafter in reference to the nozzle assembly 10 shown in FIG. 1, it will be appreciated that the teachings of the invention are more generally applicable to other types of nozzles, as well as other devices whose components are subjected to abrasive media. In addition, it should be noted that the drawings are drawn for purposes of clarity when viewed in combination with the following description, and therefore are not necessarily to scale.

The nozzle assembly 10 is represented in FIG. 1 as including a nozzle body 12, an orifice disc 14 that defines a spray orifice 16, a swirl chamber block 18 in which a swirl chamber 20 is formed with a generally tangential inlet 22, an end plate 24 abutting the swirl chamber block 14, and a retainer member 26 for retaining and positioning the orifice disc 14, swirl chamber block 18, and end plate 24 in the nozzle body 12. The nozzle body 12 includes a bore 28 formed at one end thereof for receiving the internal components of the nozzle assembly 10, and an opening 30 formed at the opposite end for the emission of spray through the orifice 16. A gasket or o-ring 32 is preferably positioned against a shoulder 34 of the body 12 that surrounds the opening 30, and the orifice disc 14 is positioned against the o-ring 32. The swirl chamber block 14 is positioned between the orifice disc 14 and end plate 24 such that one side of the swirl chamber 20 communicates with the spray orifice 16 in the orifice plate 14, and the retainer member 26 is threaded into the nozzle body 12 with threads 36 to maintain the o-ring 32, orifice plate 14, swirl chamber block 18, and end plate 24 positioned as shown in FIG. 1. The exterior of the nozzle body 12 may also have threads 38 to receive a conduit (not shown) for delivering a spray media to the nozzle assembly 10.

The flow path of the media through the nozzle assembly 10 is represented by arrows in FIG. 1 as flowing through at least one axial passage 40 within the retainer member 26, and then flowing through multiple radial passages 42 defined at the axial end of the retainer member 26 nearest the swirl chamber 20. From the passages 42,the media flows around the perimeter of the end plate 24 before entering the swirl chamber 20 through the inlet 22 of the swirl chamber block 18, where rotational flow is induced in the media before exiting through the orifice 16 in the form of an atomized spray 44.

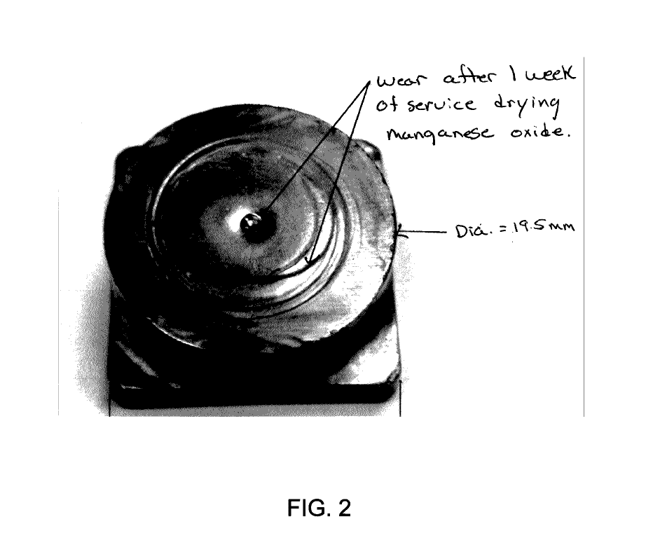

The end plate 24 represented in FIG. 1 is of a type known in the art, an image of which is shown in FIG. 2. The end plate is a one-piece component formed entirely of tungsten carbide (WC). The end plate has a generally rectangular-shaped base and a cylindrical-shaped raised portion that defines an axial surface. The flat sides at the perimeter of the base allow media to flow around the perimeter of the end plate, as was described in reference to FIG. 1. The axial surface of the raised portion of the end plate contacts the swirl chamber block 18 and, as a result, defines the swirl chamber 20 with the swirl chamber block 18 and orifice disc 14. From FIG. 2, severe wear of the end plate is visible, including generally circular-shaped wear patterns and a pit centrally located in the axial surface of the end plate. As noted in FIG. 2, these wear patterns formed over the course of a single week of drying a slurry containing manganese oxide. The wear damage to the axial surface of the end plate was sufficient to necessitate its replacement.

FIGS. 3 through 5 represent a nonlimiting embodiment of an end plate assembly 124 that is capable of replacing the end plate 24 represented in FIG. 1 and the end plate shown in FIG. 2. In one respect, the end plate assembly 124 differs from the prior art end plates of FIGS. 1 and 2 as a result of being a multi-component assembly. The end plate assembly 124 shown in FIGS. 3 through 5 comprises a wear-resistant member 126 surrounded by a second member 128 of the assembly 124, referred to herein as a ring member 128 in view of the annular shape depicted for the embodiment of FIGS. 3 through 5. The depicted embodiment of the wear-resistant member 126 is cylindrical in shape, having a circular-shaped outer perimeter and at least one planar axial surface 130 that is substantially perpendicular to an axis of symmetry of the member 126. The member 126 has a greater axial length than the ring member 128, such that a portion of the member 126 that defines the surface 130 protrudes from the ring member 128, for example, by a distance of about 5 mm.

In accordance with a preferred aspect of the embodiment shown in FIGS. 3 through 5, at least the axial surface 130 of the wear-resistant member 126 is formed of a material that exhibits greater resistance than tungsten carbide to at least one type of abrasive media, nonlimiting examples being manganese oxides (e.g., Mn₃O₄ and MnO), alumina (Al₂O₃) and alumina-based materials, iron oxides (e.g., Fe₂O₃), tungsten carbide (WC), silicon nitride (Si₃N₄), and food grade products. A particular wear-resistant material is polycrystalline diamond, for example, formed by sintering. A suitable commercial source of sintered polycrystalline diamond is US Synthetic, owned by Dover Corporation and part of the Dover Energy group. The use of other wear-resistant materials to form the surface 130 of the wear-resistant member 126 is foreseeable. In the embodiment of FIGS. 3 through 5, a wear-resistant layer 132 of sintered polycrystalline diamond is bonded to a base portion 134 of the member 126, though it is foreseeable that the entire cylindrical-shaped wear-resistant member 126 could be formed of sintered polycrystalline diamond. A nonlimiting example of a suitable material for the base portion 134 is tungsten carbide, though other materials are foreseeable.

The depicted embodiment of the ring member 128 has circular-shaped inner and outer perimeters, with axially-oriented slots 136 at its outer perimeter through which media is able to flow around the perimeter of the end plate assembly 124, similar to the flat sides of the base represented in FIGS. 1 and 2. In particular, the slots 136 enable media to flow in an axial direction around the ring member 128 between the oppositely-disposed axial ends thereof. The ring member 128 can be formed of a material that is different from that of at least the surface 130 of the wear-resistant member 126. In the depicted embodiment of the end plate assembly 124 in which the base portion 134 of the wear-resistant member 126 is formed of a single material, the entire ring member 128 can be formed of a material that is different from the base portion 134 as well as different from the wear-resistant layer 132 of the member 126. Because the particularly abrasive effects of rotational flow motion are limited to the swirl chamber 20, the ring member 128 is not subjected to abrasive wear by the spray media to the same extent that the surface 130 of the wear-resistant member 126 is, and therefore can be formed of a material that is less wear resistant than the material that forms the surface 130. However, the slots 136 of the ring member 128 are subject to some degree of abrasive wear by the media, and particular materials determined to be suitable for the ring member 128 include Type 304 and 316 stainless steels, though the use of other materials is foreseeable.

Because the wear-resistant member 126 and ring member 128 are formed of different materials, assembly of the member 126 and ring member 128 may be required to take into consideration materials having different coefficients of thermal expansion (CTE). The wear-resistant member 126 and ring member 128 can be secured together by heating the ring member 128 to cause thermal expansion, assembling the ring member 128 with the member 126, and then cooling the ring member 128 so that contraction of the ring member 128 creates a shrink (interference) fit joint between the circular-shaped inner diameter of the ring member 128 and the circular-shaped outer diameter of the wear-resistant member 126, resulting in the circular inner perimeter of the ring member 128 uniformly compressing the member 126 about its circular outer perimeter.

In investigations and evaluations leading to the present invention, tests showed that an end plate assembly as configured in FIGS. 3 through 5 and having a wear-resistant layer formed of sintered polycrystalline diamond did not degrade over a period of one year to the extent that would require replacement of the end plate assembly. Such a capability was unexpected in light of the short life of the end plate shown in FIG. 2.

While the invention has been described in terms of a specific embodiment, it is apparent that other forms could be adopted by one skilled in the art. For example, the end plate assembly 124 could differ in appearance and construction from the embodiment shown in the Figures, a nozzle assembly (or any other device) in which the end plate assembly 124 is installed could differ in appearance and construction from the embodiment shown in FIG. 1, the functions of each component of the end plate assembly 124 could be performed by components of different construction but capable of a similar (though not necessarily equivalent) function, various processes could be used to fabricate and assemble the end plate assembly 124, and appropriate materials could be substituted for those noted. In addition, aspects of the invention could lend themselves to other types of wear-resistant components for use with spray nozzle assemblies, as well as other devices adapted to handle abrasive media. Accordingly, it should be understood that the invention is not limited to the specific embodiment illustrated in the Figures. It should also be understood that the phraseology and terminology employed above are for the purpose of disclosing the illustrated embodiment, and do not necessarily serve as limitations to the scope of the invention. Therefore, the scope of the invention is to be limited only by the following claims.

1. An assembly comprising:
a wear-resistant member comprising a base portion and an axial surface, the base portion having an outer perimeter and the axial surface being formed of a first material; and
a ring member formed of a second material that is different from the first material of the axial surface of the wear-resistant member and is less resistant to abrasive wear than the first material, the ring member having an inner perimeter that surrounds and contacts the outer perimeter of the base portion of the wear-resistant member.

2. The assembly according to claim 1, wherein the wear-resistant member has a cylindrical shape and the outer perimeter of the base portion has a circular shape.

3. The assembly according to claim 1, wherein the axial surface of the wear-resistant member is defined by a wear-resistant layer on the base portion.

4. The assembly according to claim 1, wherein the first material of the axial surface of the wear-resistant member is more wear resistant than tungsten carbide.

5. The assembly according to claim 4, wherein the first material of the axial surface is sintered polycrystalline diamond.

6. The assembly according to claim 1, wherein the inner perimeter of the ring member has a circular shape.

7. The assembly according to claim 6, wherein the ring member has an outer perimeter having a circular shape.

8. The assembly according to claim 7, further comprising axially-oriented slots defined in the outer perimeter of the ring member to allow axial flow of a media around the ring member from a first axial end of the ring member to an oppositely-disposed second axial end of the ring member.

9. The assembly according to claim 1, wherein the wear-resistant member is secured within the inner perimeter of the ring member by a shrink-fit.

10. The assembly according to claim 1, wherein the axial surface of the wear-resistant member is defined by a portion of the wear-resistant member that protrudes from the inner perimeter of the ring member.

11. The assembly according to claim 1, wherein the assembly is an end plate assembly of a spray nozzle assembly.

12. An end plate assembly installed in a spray nozzle assembly that comprises an orifice disc and a swirl chamber member between the end plate assembly and the orifice disc to define a swirl chamber therebetween, the end plate assembly comprising:
a wear-resistant member comprising a base portion and an axial surface, the base portion having an outer perimeter, the axial surface being formed of a first material exposed within the swirl chamber; and
a ring member formed of a second material that is different from the first material of the axial surface of the wear-resistant member and is less resistant to abrasive wear than the first material, the ring member having an outer perimeter and an inner perimeter that surrounds and contacts the outer perimeter of the base portion of the wear-resistant member.

13. The end plate assembly according to claim 12, wherein the wear-resistant member has a cylindrical shape and the outer perimeter of the base portion has a circular shape.

14. The end plate assembly according to claim 12, wherein the axial surface of the wear-resistant member is defined by a wear-resistant layer on the base portion.

15. The end plate assembly according to claim 12, wherein the first material of the axial surface of the wear-resistant member is more wear resistant than tungsten carbide.

16. The end plate assembly according to claim 15, wherein the first material of the axial surface is sintered polycrystalline diamond.

17. The end plate assembly according to claim 12, wherein the inner perimeter of the ring member has a circular shape.

18. The end plate assembly according to claim 17, further comprising axially-oriented slots defined in the outer perimeter of the ring member, the axially-oriented slots enabling axial flow of a media around the ring member prior to entering the swirl chamber of the spray nozzle assembly.

19. The end plate assembly according to claim 12, wherein the wear-resistant member is secured within the inner perimeter of the ring member by a shrink-fit.

20. The end plate assembly according to claim 12, wherein the axial surface of the wear-resistant member is defined by a portion of the wear-resistant member that protrudes from the inner perimeter of the ring member.
